(19) United States
(12) Patent Application Publication
(10) Pub. No.: US 2019/0261753 A1
(43) Pub. Date: Aug. 29, 2019

(54) Interchangeable strap attachment and item for receiving the attachment

(71) Applicants: Carolle Lynn Cornish, Fox Valley (CA); Geoffrey Simon Waterhouse, Fox Valley (CA)

(72) Inventors: Carolle Lynn Cornish, Fox Valley (CA); Geoffrey Simon Waterhouse, Fox Valley (CA)

(21) Appl. No.: 15/984,394

(22) Filed: May 20, 2018

Related U.S. Application Data
(60) Provisional application No. 62/509,169, filed on May 21, 2017.

(51) Int. Cl. A45C 13/30; G10G 5/00; F41C 33/00; A45C 13/00

(52) U.S. Cl. CPC A45C 13/30; A45C 13/001; F41C 33/002; G10G 5/005

(57) ABSTRACT

An interchangeable strap attachment that can be detachably attached to a musical instrument strap or firearm strap that has a receptacle for receiving the attachment. The interchangeable strap attachment has a body with two ends; both ends have at least one dimension sized to fit within, around or onto the receptacle or receptacles of the musical instrument strap or firearm strap. The bottom underside of the interchangeable strap attachment has an attaching device near each end that attaches to the receiving devices on the body of the musical instrument strap or firearm strap.

### REFERENCE TO RELATED APPLICATION

This application claims priority to the earlier filed U.S. Provisional Application No. 62/509,169 filed on May 21, 2017 and hereby incorporates subject matter of the provisional application.

### FIELD OF INVENTION

The present invention relates to the field of musical instrument straps and firearm straps. More particularly, the present invention relates to an interchangeable strap attachment and item for receiving the attachment.

### BACKGROUND OF THE INVENTION

Straps have been in use for some time. In particular, musical instrument straps, and firearm straps have been in use for some time.

Musicians have desires to adorn themselves with articles that allow them to express their individuality and attract attention. The music industry is a multi billion dollar worldwide business.

The ability to interchange, personalize, and accessorize has always been a large part of the music industry and musicians usually have numerous different articles of clothing, accessories, instruments, and musical instrument straps to suit their mood, personality, desired overall image, and/or to promote their brand identity. It is an innate human desire to transform an item from an object one has purchased to an object that resonates with the owners' dynamic personality, clothing, accessories, current mood, or brand identity. The Interchangeable strap attachment and item for receiving the attachment will assist people in accomplishing the above.

Currently, if a musician wants to personalize their musical instrument strap they have to purchase a musical instrument strap with a distinct color, material, design, pattern, look, or brand identifier. If they want to express their individuality further to correspond with changing trends, ideologies, brand identity, or personal preference, they have to purchase numerous musical instrument straps. For example, during a musical performance if a musician wants to change their overall look, they have to change their musical instrument strap. With the interchangeable strap attachment the musician can now, quickly, and easily swap out one attachment with a specific material, color, pattern, design, overall image, or brand identity for another attachment without having to change their entire musical instrument strap which can be time-consuming, cumbersome, and create unnecessary wear & tear on the strap and/or the musical instrument.

Firearm owners have desires to adorn themselves with articles that allow them to express their individuality and attract or prevent attention. The firearm industry is a multi billion dollar worldwide business.

The ability to interchange, personalize, and accessorize has always been a large part of the firearm industry and firearm owners usually have numerous different styles of firearms, accessories, and firearm straps to suit their overall mood, personality, and firearm situational usage requirements. It is an innate human desire to transform an item from an object one has purchased to an object that resonates with the owners' dynamic personality, clothing, accessories, or current situation. The Interchangeable strap attachment and item for receiving the attachment will assist people in accomplishing the above.

Currently, if a firearm owner wants to personalize their firearm strap they have to purchase a particular firearm strap with a distinct color, material, pattern, design, or overall look. If they want to express their individuality further to correspond with changing trends, ideologies, situations, or personal preference, they have to purchase numerous different firearm straps. For example, while hunting, if a firearm owner wants to change their overall camouflage, they have to change their firearm strap. With the interchangeable strap attachment the firearm owner can now, quickly, and easily swap out one attachment with a specific color, material, pattern, design, or overall image for another attachment without having to change their entire firearm strap which can be time-consuming, cumbersome, and create unnecessary wear & tear on the strap and/or the firearm.

Accordingly, there is a need for an interchangeable strap attachment that can be conveniently attached to or detached from a musical instrument strap or firearm strap.

### SUMMARY OF THE INVENTION

The present invention relates to an interchangeable strap attachment and item for receiving the attachment.

It is an object of the invention to provide an interchangeable strap attachment, and a convenient system of detachably attaching the attachment to the item.

According to the present invention there is provided an interchangeable strap attachment for detachable attachment to a receptacle of a item, the attachment comprising:

a body having at least one dimension that is sized to fit within, around, or onto the receptacle of the item

According to the present invention there is provided a receptacle for receiving an interchangeable strap attachment. The receptacle may be incorporated into any item, or any item may be configured or manufactured to comprise a receptacle. In a particular aspect of the invention there is provided a musical instrument strap with a receptacle for receiving an interchangeable strap attachment the musical instrument strap comprising:

a base,

the base having a receptacle to fit at least one dimension of a body of the interchangeable strap attachment.

In certain aspects of the present invention, a receptacle may be a D-ring attached to the base of the item, the interchangeable strap attachment would attach to the D-ring and then be secured with a suitable securing item, or substance, such as but not limited to Chicago screws, rivets, glue, thread. In certain other aspects, the receptacle may be Velcro attached to the base of the item, the opposing side of the Velcro being attached to the body of the interchangeable strap attachment at the same position as on the receptacle. In certain other aspects, the receptacle may be snaps attached to the base of the item, the opposing piece of the snap being attached to the body of the interchangeable strap attachment at the same position as on the receptacle. In particular examples, the receptacle may be a pocket attached to the base of the item, the pocket is of a suitable size to snugly receive an end of the interchangeable strap attachment being inserted into the pocket.

The summary of the invention does not necessarily describe all the features of the invention.

These and other features of the invention will become more apparent from the following description in which reference is made to the appended drawings wherein:

### BRIEF DESCRIPTION OF THE DRAWINGS

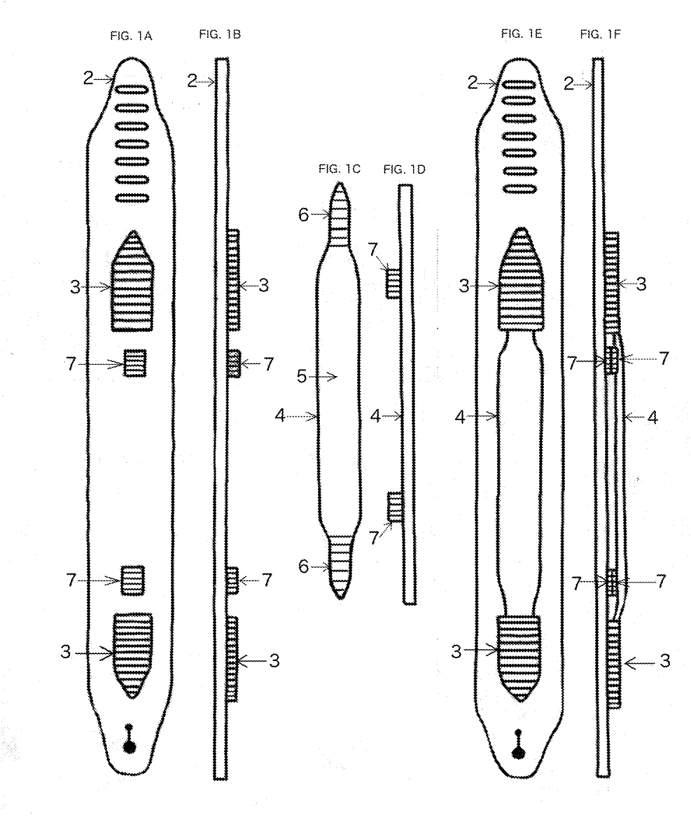

Drawing 1 shows the top and side views of a musical instrument strap in accordance with an embodiment of the present invention. FIGS. 1A and 1B show top and side views of a musical instrument strap with empty receptacles; FIGS. 1C and 1D show top and side views of an interchangeable strap attachment; FIGS. 1E and 1F shows the top and side views of musical instrument strap with an interchangeable strap attachment attached within the receptacles;

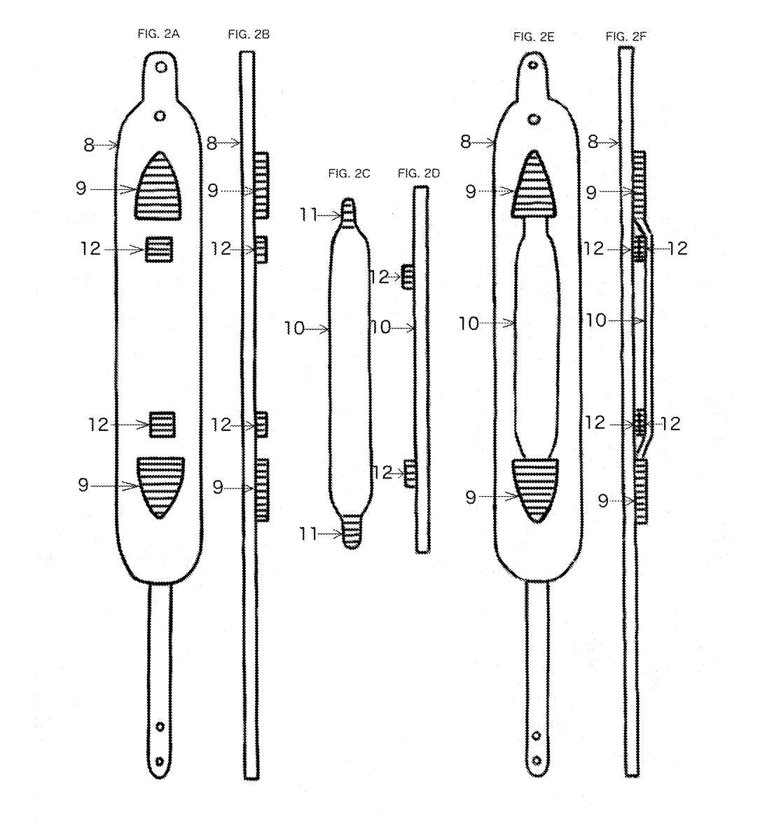

Drawing 2 shows the top and side views of a firearm strap. FIGS. 2A and 2B show top and side views of a firearm strap with empty receptacles; FIGS. 2C and 2D show top and side views of an interchangeable strap attachment; FIGS. 2E and 2F shows the top and side views of a firearm strap with an interchangeable strap attachment attached within the receptacles in accordance with a further embodiment of the present invention;

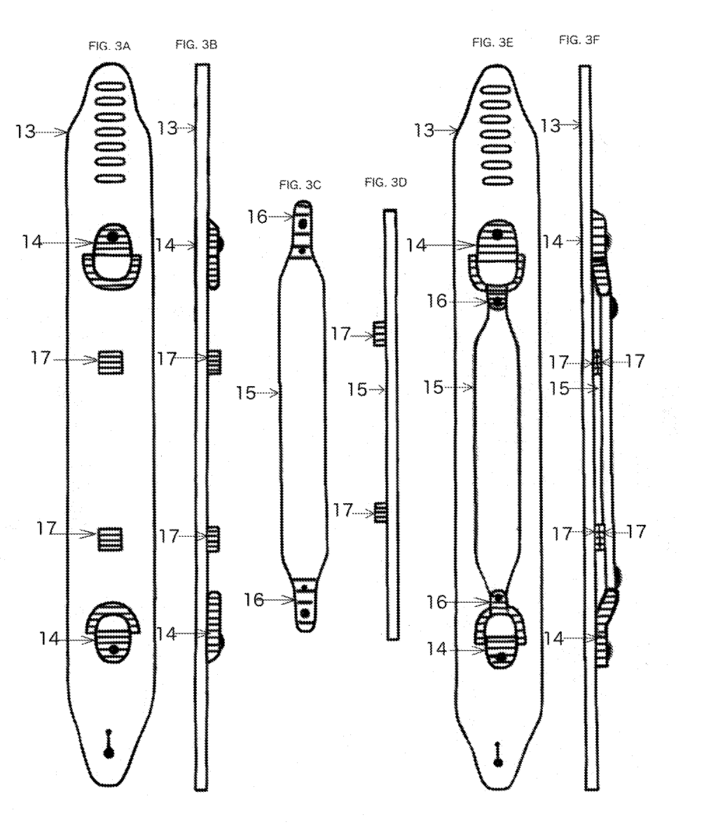

Drawing 3 shows the top and side views of a musical instrument strap. FIGS. 3A and 3B show the top and side views of a musical instrument strap with empty receptacles; FIGS. 3C and 3D show top and side views of an interchangeable strap attachment; FIGS. 3E and 3F show to the top and side views of a musical instrument strap with an interchangeable strap attachment attached onto the receptacles in accordance with a further embodiment of the present invention;

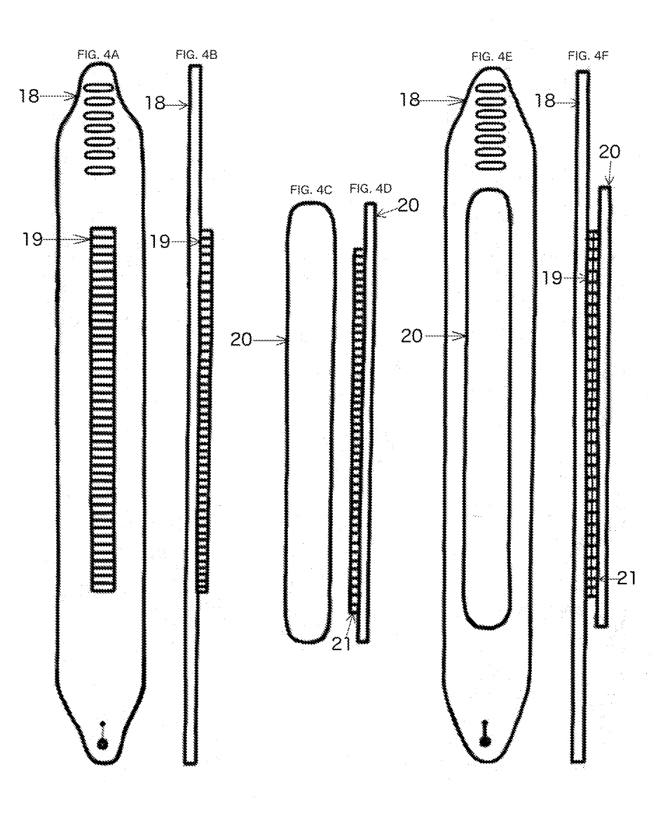

Drawing 4 shows the top and side views of a musical instrument strap. FIGS. 4A and 4B show the top and side views of a musical instrument strap with an empty receptacle; FIGS. 4C and 4D show top and side views of an interchangeable strap attachment; FIGS. 4E and 4F show the top and side views of a musical instrument strap with an interchangeable strap attachment attached onto the receptacle in accordance with a further embodiment of the present invention.

### DETAILED DESCRIPTION OF THE INVENTION

The following description is of a preferred embodiment.

The types of items for receiving an interchangeable strap attachment are a musical instrument strap (strap that supports a musical instrument) or a firearm strap (strap that supports a firearm). As will be recognized by persons skilled in the art, a musical instrument strap surface or a firearm strap surface may be manufactured to have a receptacle or receptacles for receiving an interchangeable strap attachment. Interchangeable strap attachments may be standardized such that a single interchangeable strap attachment can fit into, onto, or around a variety of musical instrument straps and firearm straps, or that a single musical instrument strap or firearm strap can be fitted with a variety of interchangeable strap attachments.

In examples of the present invention a musical instrument strap or firearm strap has one or more receptacles or chambers for receiving an interchangeable strap attachment. The receptacle or receptacles comprise of a musical instrument strap or firearm strap having at least one dimension to fit around, onto, or together with the body of an interchangeable strap attachment. The body of the interchangeable strap attachment will have at least one dimension sized to fit around, within, or onto the receptacle of a musical instrument strap or firearm strap.

In one example, the receptacles are pockets attached to the musical instrument strap or firearm strap on two opposing ends and the interchangeable strap attachment has a portion on two opposing ends that are sized to insert into the pocket openings, the musical instrument strap or firearm strap also has a securing attachment device such as but not limited to Velcro on two opposing ends and the back underneath side of interchangeable strap attachment also has a securing attachment device on two opposing ends which attach to the securing attachment devices on the musical instrument strap or firearm strap.

In another example the musical instrument strap or firearm strap has a receptacle with an attachment device such as, but not limited to a D-Ring attached at two opposing ends and the interchangeable strap attachment has a portion on the two opposing ends that connects to or loops through the attachment device on the two opposing ends of the musical instrument strap or firearm strap. The portion that loops through the attachment device is then secured with but not limited to Chicago screws, Velcro, snaps, or other types of detachable securing devices.

In another example the musical instrument strap or firearm strap has a receptacle with an attachment device such as but not limited to Velcro on the front top side and the interchangeable strap attachment has an attachment device such as but not limited to Velcro on the back underneath side, which is then connected to the securing attachment device or devices on the musical instrument strap or firearm strap.

The body of the interchangeable strap attachment may be made of any suitable material. In certain examples, an interchangeable strap attachment made of leather may be used; the shape of the interchangeable strap attachment having at least one dimension sized to fit around, onto, or within a receptacle, and further the interchangeable strap attachment may contain decorative elements. The musical instrument strap or firearm strap may be of any material known to a musical instrument strap or firearm strap manufacturer including, without limitation, leather, fabric, plastic, rubber, metal, or combinations thereof.

The interchangeable strap attachment may be any shape provided it has as least one dimension that is sized to fit around, onto, or within a receptacle of a musical instrument strap or firearm strap.

External force must be applied to attach or detach the interchangeable strap attachment with respect to a receptacle. Typically, a musical instrument strap wearer will push the interchangeable strap attachment into or onto the receptacle of a musical instrument strap such that the interchangeable strap attachment engages a surface of the receptacle. Any surface of the receptacle may be engaged provided that a secure fit is achieved. Once attached an interchangeable strap attachment remains secure until sufficient force is exerted on the attachment, either by pushing or pulling, or unscrewing, to cause the attachment to be released from engagement with the receptacle. Accordingly, examples of the present invention demonstrate a simplified and convenient system for attaching or detaching an interchangeable strap attachment within, around, or onto, a musical instrument strap or firearm strap receptacle.

The present invention is further illustrated using examples that are depicted in the drawings.

FIGS. 1A and 1B on Drawing 1 show the top and side views of a musical instrument strap (2) having receptacles (3) and FIGS. 1C and 1D show the top and side views of an interchangeable strap attachment (4) and FIGS. 1E and 1F show the top and side views of a musical instrument strap (2) having an interchangeable strap attachment (4) attached within the receptacles (3). The interchangeable strap attachment (4) has a body (5) that has a portion (6) on two opposing ends that are sized to fit snugly into the receptacles (3), the musical instrument strap (2) also has a securing attachment device (7) such as but not limited to pieces of Velcro on two opposing ends and the back underneath side of the interchangeable strap attachment (4) has a securing attachment device (7) on two opposing ends which attach to the securing attachment device (7) on the musical instrument strap(2).

FIGS. 2A and 2B on Drawing 2 show the top and side views of a firearm strap (8) having receptacles (9) and FIGS. 2C and 2D show the top and side views of an interchangeable strap attachment (10) and FIGS. 2E and 2F show the top and side views of a firearm strap (8) having an interchangeable strap attachment (10) attached within the receptacles (9). The interchangeable strap attachment (10) has a portion (11) on two opposing ends that are sized to fit snugly into the receptacles (9), the firearm strap (8) also has a securing attachment device (12) such as but not limited to pieces of Velcro on two opposing ends and the back underneath side of the interchangeable strap attachment (10) has a securing attachment device (12) on two opposing ends which attach to the securing attachment device (12) on the firearm strap (8).

FIGS. 3A and 3B on Drawing 3 show the top and side views of a musical instrument strap (13) having receptacles (14) and FIGS. 3C and 3D show the top and side views of an interchangeable strap attachment (15) and FIGS. 3E and 3F show the top and side views of a musical instrument strap (13) having an interchangeable strap attachment (15) attached to the receptacles (14). The interchangeable strap attachment (15) has a portion (16) on two opposing ends that are sized to fit through and around the receptacles (14), the portion (16) that was fitted through and around the receptacles (14) is then secured with securing device such as but not limited to Chicago Screws, the musical instrument strap (13) also has a securing attachment device (17) such as but not limited to Velcro, on two opposing ends and the back underneath side of the interchangeable strap attachment (15) has a securing attachment device (17) on two opposing ends which attach to the securing attachment device (17) on the musical instrument strap (13).

FIGS. 4A and 4B on Drawing 4 show the top and side views of a musical instrument strap (18) having a receptacle (19) and FIGS. 4C and 4D show the top and side views of an interchangeable strap attachment (20) and FIGS. 4E and 4F show the top and side views of a musical instrument strap (18) having an interchangeable strap attachment (20) attached to the receptacle (19). The musical instrument strap (18) has a securing attachment device such as but not limited to Velcro on the body of the musical instrument strap (18) and the back underneath side of the interchangeable strap attachment (20) has a securing attachment device (21) which attaches to the receptacle (19) on the musical instrument strap (18).

All citations are hereby incorporated by reference.

The present invention has been described with regard to one or more embodiments. However, it will be apparent to persons skilled in the art that a number of variations and modifications can be made without departing from the scope of the invention as defined in the claims.

1. An interchangeable strap attachment for detachable attachment to a receptacle of an item, the attachment comprising: a body having at least one dimension that is sized to fit within, onto, or around the receptacle or receptacles of a musical instrument strap or firearm strap.

2. An item having a receptacle or receptacles for detachably attaching the interchangeable strap attachment of claim 1.

3. The item of claim 1 and claim 2, wherein the item is selected from musical, instrument straps or firearm straps.

4. The item of claim 2, wherein the receptacle comprises: at least one dimension or means of attachment, to fit around, onto, or together with the body of the interchangeable strap attachment.
